(19) United States
(12) Patent Application Publication
(10) Pub. No.: US 2008/0103237 A1
(43) Pub. Date: May 1, 2008

(54) AQUEOUS FILM-FORMING COMPOSITIONS CONTAINING REDUCED LEVELS OF VOLATILE ORGANIC COMPOUNDS

(76) Inventors: Arron Strepka, LaGrange Park, IL (US); Makarand V. Joshi, Grayslake, IL (US); William D. Arendt, Libertyville, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/554,301

(22) Filed: Oct. 30, 2006

(51) Int. Cl. C08K 5/10; C08K 5/05; C09D 5/02

(52) U.S. Cl. 524/306; 524/556; 524/379; 524/386

(57) ABSTRACT

In addition to acting as effective plasticizers, benzoic acid ester combinations comprising diesters of glycols and at least one of the corresponding monoesters within a specified concentration range are unique in their ability to act as coalescents for aqueous polymer compositions, thereby replacing more volatile organic compounds such as diols, glycols and esters of mono- and dihydric alcohols and benzoates of monohydric alcohols containing 8-10 carbon atoms. Within a preferred concentration range the benzoate combinations impart additional desirable properties to films formed from the polymer composition. These combinations can replace at least a portion of the more volatile organic compounds without any decrease in coalescing ability of the polymers present in the composition.

### FIELD OF THE INVENTION

This invention relates to aqueous film-forming polymer compositions. More particularly, this invention relates to lowering the concentration of volatile organic compounds, referred to as the VOC content, of these compositions by replacing prior art coalescing agents with less volatile ones without adversely affecting other desirable properties of the composition. This is achieved using combinations of mono- and dibenzoates of glycols as replacements for the more volatile organic compounds conventionally used as coalescents in these compositions. The compositions include but are not limited to coatings, self-supporting films, adhesives, sealants, inks, overprint varnishes and caulks.

### RELATED PRIOR ART

The use of benzoic acid esters as plasticizers for a variety of organic polymer compositions is well known. Patents disclosing the use of dibenzoates of dihydric alcohols alone or in combination with the corresponding monobenzoates include U.S. Pat. Nos. 6,583,207; 5,676,742; and 5,990,214.

U.S. Pat. No. 6,583,207 to Stanhope et al. discloses that while pure diethylene glycol dibenzoate is a solid at 25° C., blends of this ester with at least about 30 weight percent of the monobenzoate of a glycol or dihydric alcohol containing from 2 to 8 carbon atoms are liquid at this temperature in addition to being effective plasticizers for aqueous polymer compositions. The efficacy of the benzoate blends as coalescents in coating compositions is not discussed.

U.S. Pat. No. 5,676,742, issued to Arendt et al., teaches that presence of diethylene glycol monobenzoate or dipropylene glycol monobenzoate imparts resistance to microbial growth when the corresponding dibenzoates are used as plasticizers in aqueous caulk compositions.

Aqueous polymer compositions employed, for example, as coatings, inks, adhesives, caulks and sealants typically require the presence of relatively volatile organic compounds such as alcohols, esters and glycol ethers to achieve desirable properties. These properties include but are not limited to coalescing of the particles of film-forming polymer at temperatures below the glass transition temperature of the polymers, resisitance to gelation of the composition during repeated cycles of freezing and thawing and the adhesion, leveling, toolability, wet-edge and gloss development, and resistance to scrubbing and organic solvents exhibited by films and coatings applied using the compositions.

Recently several national and regional governments have issued restrictions concerning the amounts of volatile organic compounds (VOC's) that can be present in compositions intended for use as coatings, inks, sealants, adhesives and related applications. These restrictions have initiated efforts by manufactures and formulators of these compositions to seek ways to eliminate or at least reduce the concentration of VOC's in both aqueous and non-aqueous polymer compositions without adversely affecting the beneficial properties imparted by these compounds.

U.S. Pat. No. 6,762,230, which issued to L. Brandenburger et al. on Jul. 13, 2004 teaches lowering the VOC level in aqueous coating compositions containing latex polymers by replacing conventional coalescents such as Texanol® (2,2-dimethyl-1,3-pentanediol monoisobutyrate), a conventional coalescent, with relatively low molecular weight reaction products of 1) lactones with monohydric alcohols or 2) glycidyl esters with monocarboxylic acids. Coating compositions containing these reaction products exhibited lower VOC values than a coating prepared using Texanol®. When evaluated for scrubability, coatings prepared using these reaction products were equivalent to coatings prepared using the Texanol ester.

U.S. Pat. No. 5,236,987, which issued to William D. Arendt on Aug. 17, 1993 teaches using benzoic acid esters of monohydric alcohols containing from 8 to 12 carbon atoms as replacements for conventional coalescents for aqueous coating compositions. Latex paint compositions containing isodecyl benzoate as the coalescent exhibited scrub resistance values that were at least equivalent to ones containing Texanol®. The VOC content of isodecyl benzoate is about 22%.

One objective of this invention is to replace the relatively volatile alkyl benzoates of the Arendt patent with less volatile benzoic acid esters. One apparent disadvantage of this approach is that the resultant higher concentration of the less volatile coalescents in the final product such as a coating or sealant would be expected to adversely affect physical properties such as resistance to scrubbing and solvents.

The present invention is based on the discovery that combinations of 1) one or more dibenzoates of monomeric or oligomeric ethylene and/or propylene glycols, 2) a relatively high concentration of at least one of the corresponding monobenzoates and 3) no more than 10 weight percent of unreacted benzoic acid are effective coalescents for aqueous polymer compositions in addition to being effective plasticizers. Using a preferred range of ratios of mono- to dibenzoate levels of desirable coating properties such as resistance to scrubbing and solvents are at least equivalent to coatings prepared using compositions containing the more volatile coalescents of the prior art, including the alkyl benzoates described in the aforementioned Arendt patent.

The ester compositions of this invention can either replace at least a portion of more volatile organic compounds previously employed as coalescents in aqueous polymer compositions without adversely affecting desirable coating properties or can increase the level of properties imparted by a given concentration of these organic compounds.

### SUMMARY OF THE INVENTION

This invention provides low VOC aqueous polymer compositions comprising:
A. at least one film-forming organic polymer;
B. as a coalescent for said polymer, an effective amount of a benzoic acid ester combination comprising:
   1) at least one diester of the formula PhC(O)(OR¹)_{q}O(O)CPh;
   2) from 6 to 99 weight percent, based on the total weight of said combination, of at least one monoester of the generic formula PhC(O)(OR²)ᵣOH, wherein R¹ and R² are individually at least one member selected from the group consisting of alkyl radicals containing 2 or 3 carbon atoms, Ph is phenyl or alkylphenyl, and q and r are individually integer from 1 to 6, inclusive, and
   3) from 0 to 10 weight percent, based on the weight of said benzoate composition, of unreacted benzoic acid;
C. an amount sufficient to achieve the desired modification of the film-forming properties of said organic polymer of least one water-miscible compound selected from the group consisting of dihydric alcohols, glycols, oligomeric glycols, esters of said alcohols and glycols, and ethers; and
D. water.

### DETAILED DESCRIPTION OF THE INVENTION

The benzoate combinations of this invention are useful in a variety of aqueous polymer compositions, including but not limited to coating compositions, caulks, inks, self-supporting films, adhesives, overprint varnishes and sealants. In addition to the present ester combinations the compositions typically include at least one film-forming organic polymer, water, and a variety of organic compounds whose functions include but are not limited to coalescents, surfactants, and film modifiers.

All of the benzoate ester combinations of this invention can be used as replacements for the more volatile organic compounds, including the benzoates described in the aforementioned Arendt patent. Conventional prior art coalescents are typically volatile liquid organic compounds including but not limited to dihydric alcohols, glycols, oligomeric glycols, esters of said alcohols and glycols, and ethers. Preferred prior art coalescents are esters of aliphatic dicarboxylic acids such as Texanol® and Texanol® diisobutyrate.

The present combinations of benzoic acid esters include at least one diester of the generic formula PhC(O)(OR¹O )_{q}(O)CPh and at least one monobenzoate of the generic formula PhC(O)(OR²O)ᵣH, wherein R¹ and R² are individually at least one member selected from the group consisting of alkyl radicals containing 2 or 3 carbon atoms, Ph is phenyl or alkyl-substituted phenyl, and q and r are individually integers from 1 to 6, inclusive. The monobenzoate(s) constitute from 6 to 99, preferably from 6 to 15 weight percent of the ester combination, and the concentration of unreacted benzoic acid is less than one weight percent.

When R¹ and R² are ethyl the values of q and r are preferably from 2 to 4. When R¹ and R² are propyl these values are from 1 to 6.

Preferred benzoate esters include but are not limited to the mono- and dibenzoates of diethylene glycol and dipropylene glycol and mixtures of these esters.

The present benzoate compositions typically constitute from about 1 to about 200 weight percent, based on the weight of film-forming polymers in the polymer composition.

The benzoate compositions of this invention at least partially replace the more volatile liquid organic compounds conventionally used to achieve desired levels of coalescence and film properties. These organic compounds include the benzoate esters of monohydric alcohols disclosed in the aforementioned Arendt patent.

Besides functioning as coalescing agents, benzoate ester combinations of this invention containing a total of from 6 to 15 weight percent of monobenzoates improve other properties of the polymer composition and/or of coatings applied using the compositions. These properties include but are not limited to resistance to gelation of the polymer compositions during freeze-thaw cycles, and the resistance of the applied coatings to scrubbing, solvents and salt fog. The definitions of the forgoing properties are known to those skilled in the art of formulating coating compositions.

Organic polymers suitable for use as the film-forming ingredient in the aqueous compositions of the present invention include but are not limited to homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, epoxy-modified acrylic polymers, and mixtures of two or more of the aforementioned polymers.

The end use applications of the aqueous polymer compositions of the present invention include but are not limited to coating, including paints, adhesives, sealants, over-print varnishes, caulks, inks, and self-supporting films.

The following examples describe preferred coating compositions containing the benzoate combinations of this invention. The examples should not be interpreted as limiting the scope of benzoate combinations and film-forming compositions encompassed by the accompanying claimed. Unless otherwise indicated all parts and percentages in the examples are by weight and properties were measured at 25° C.

### EXAMPLE 1

Three benzoic ester combinations of this invention, identified as 1, 2 and 3, and one comparative purposes, identified as 1C, were prepared by reacting benzoic acid with diethylene glycol and/or dipropylene glycol in the molar ratios specified in table 1 using 0.03 weight percent of zirconium carbonate as the esterification catalyst. The compositions of these combinations in weight percent are listed in Table 1

TABLE 1

| | % | | |
|---|---|---|---|
| COMBINATION | DEGDB | % DPGDB | % MONOBENZOATE(S) |
| 1 | 65 | 23 | 12^{a} |
| 2 | 60 | 0 | 40^{b} |
| 3* | 60 | 0 | 21 |
| 1C | 47 | 47 | 6 |

^{a}= a mixture of diethylene glycol monobenzoate and dipropylene glycol monobenzoate
^{b}= diethylene glycol monobenzoate
*= Combination 3 also contained 19 weight percent of 2-ethylhexyl benzoate based on the combined weight of all benzoate esters

For purposes of comparison the following known coalescents were also evaluated: Texanol®; Texanol® isobutyrate; and a 1:2 weight ratio blend of Texanol and the benzoate combination identified as 1C in Table 1.

Four paint compositions, referred to hereinafter as A, B, C and D, were prepared by mixing the ingredients in upper portion of Table 2 on a paint mill. The resultant material, referred to in the table as a premix, was then combined with the ingredients in the lower portion of the table (below “ADD”) to form the final paint. The concentrations of all ingredients listed in Table 2 are in parts by weight.

TABLE 2

| A | | B | | C | | D | |
|---|---|---|---|---|---|---|---|
| Water | 293.2 | Propylene Glycol | 21.5 | Water | 117.2 | Water | 192.0 |
| ER 15000 | 2.0 | Tamol 165 | 8.7 | Propylene | 3.0 | Tamol 850 | 9.0 |
| | | | | Glycol | | | |
| Nuosept 145 | 2.4 | Tego 805 | 2.1 | AMP 95 | 2.0 | KTPP | 1.5 |
| Tamol 731 | 9.2 | Kathon LX 1.5% | 1.7 | BYK 024 | 1.0 | AMP 95 | 1.7 |
| Triton N-57 | 2.1 | TiPure R-706 | 225.0 | Proxel GXL | 0.7 | Igepal CO 630 | 3.0 |
| AMP 95 | 1.0 | Water | 41.7 | Tamol 165 A | 10.8 | Hi-Mar DFC19 | 2.0 |
| Propylene Glycol | 17.2 | Aq. NH₃ (28%) | 2.0 | Triton CF 10 | 2.0 | Nuosept 95 | 1.5 |
| BYK 035 | 1.0 | | | Acrysol RM | 31.5 | Tipure | 200.0 |
| | | | | 2020NPR | | R-706 | |
| Tronox CR 800 | 250.0 | | | Ti-Pure | 221.6 | Mattex | 110.0 |
| | | | | R-706 | | | |
| ADD | | ADD | | ADD | | No. 10 White | 150.0 |
| PREMIX NEXT THREE | | Water | 50.0 | NeoCryl | 561.5 | Cellite 281F | 40.0 |
| | | | | XK 225 | | | |
| Propylene Glycol | 10.0 | Rhoplex SG 20 | 533.7 | Water | 36.0 | Attagel 40 | 10.0 |
| SCT 275 | 10.0 | Triton GR-7M | 2.1 | Triton N-57 | 4.9 | ADD | |
| Water | 10.0 | Tego 805 | 2.5 | BYK 333 | 2.0 | Airflex EF 811 | 216.1 |
| THEN ADD | | Aq. NH₃ (28%) | 1.4 | BYK 024 | 3.0 | Natrosol | 145 |
| | | | | | | Plus (3% Soln. | |
| UCAR 379 G | 428.4 | Acrysol RM 2020 | 19.3 | Acrylsol | 1.2 | Hi-Mar DFC 19 | 2.0 |
| | | | | RM 825 | | | |
| BYK 035 | 1.9 | Acrysol RM 8W | 2.0 | | | Hi-Mar DFC 19 | 2.0 |
| Triton GR 7M | 0.5 | Water | 90.0 | | | Water | 93.1 |

| | | | |
|---|---|---|---|
| Coalescent: See Table 3 | Coalescent: See Table 3 | Coalescent: See | Coalescent: See |
| | | Table 3 | Table 3 |

Benzoate combinations 1, 2, 3 and 1C/Texanol® were blended as coalescents into separate portions of each of the four paint formulations in Table 2. The concentrations of the coalescents in parts by weight are listed in Table 4 together with the VOC level of the final composition in grams per liter.

All of the ingredients listed in Table 2 and in subsequent tables of ions are identified in the following Table 3.

TABLE 3

| Material | Supplier | Description |
|---|---|---|
| Acrysol RM 2020 NPR | Rohm and Haas | Rheology Modifier |
| Acrysol RM 825 | Rohm and Haas | Associative Thickener |
| Acrysol RM 8W | Rohm and Haas | Rheology Modifier |
| Airflex EF 811 | Air Products | Vinyl Acetate Ethylene Emulsion |
| AMP 95 | Angus | dispersant |
| Attagel 40 | Engelhard | Thickener |
| Avanse MV-100 | Rohm and Haas | Acrylic Emulsion |
| BYK 024 | BYK-Chemie, USA | Defoamer |
| BYK 035 | BYK-Chemie, USA | Deoamer |
| BYK 333 | BYK-Chemie, USA | Surface Additive |
| Celite 281F | Celite | Pigment Extender |
| Cellosize ER 15000 | Dow/Union Carbide | Thickener |
| Drew Plus L-493 | Ashland-Drew Industrial | Defoamer |
| DPnB | Dow | Filming Aid |
| Hi-Mar DFC 19 | Hi-Mar Specialty Chemicals LLC | Defoamer |
| Igepal CO 630 | Rhone-Poulenc Surfactants and Specialties | Wetting Agent |
| Kathon LX | Rohm and Haas | Preservative |
| Mattex | Engelhard Corp | Pigment |
| Natrasol Plus 330 Plus | Aqualon | Thickener |
| NeoCryl XK 225 | DSM NeoResins | Styrenated Acrylic Emulsion |
| No. 10 White | Georgia Marble | Pigment Extender |
| Nuosept 145 | Huls America | Preservative |
| Nuosept 95 | Huls America | Preservative |
| Proxel GXL | Zeneca Biocides | Antimicrobial |
| Rhoplex SG 20 | Rohm and Haas | Acrylic Emulsion |
| SCT 275 | Rohm and Haas | Thickener |
| Surfynol CT-111 | Wetting aid | Air Products and Chemicals Inc. |
| Tamol 165 | Rohm and Haas | Dispersant |
| Tamol 165A | Rohm and Haas | Dispersant |
| Tamol 731 | Rohm and Haas | Dispersant |
| Tamol 850 | Rohm and Haas | Dispersant |
| Tamol 2001 | Rohm and Haas | Dispersant |
| Tego 805 | Goldschmidt Industrial Specialties | Defoamer |
| Texanol | Eastman | Filming Aid |
| Texanol isobutyrate | Eastman | Filming Aid |
| TiPure R-706 | DuPont | Pigment |
| Triton CF 10 | Dow/Union Carbide | Wetting Agent |
| Triton GR 7M | Dow/Union Carbide | Wetting Agent |
| Triton N-57 | Dow/Union Carbide | Emulsifier |
| Tronox CR 800 | Kerr-McGee | Pigment |
| UCAR 379G | Dow Ucar Emulsions | Vinyl Acrylic Emulsion |

The formulations described in Table 2 were evaluated for scrub resistance using a following the procedure described in ASTM test procedure D 2486

The concentrations of the coalescents in parts by weight, the VOC's of the coalescents and the results of the evaluations are recorded in Table 4.

TABLE 4

| | COMPOSITION | | | |
|---|---|---|---|---|
| | A | B | C | D |
| Coalescent 1 | 8.0 | 14.3 | 31.9 | 8.9 |
| Formulation VOC (g./liter) | 91 | 66 | 19 | 5 |
| Scrub Resistance (cycles) | 5402 | 466 | 382 | 261 |
| Texanol Diisobutyrate (Control) | 8.0 | NE | NE | NE |
| Formulation VOC (g./liter) | 115 | | | |
| Scrub Resistance (cycles) | 3424 | | | |
| Texanol (Control) | NE | 14.3 | NE | NE |
| Formulation VOC (g./liter) | | 106 | | |
| Scrub Resistance (cycles) | | 435 | | |
| Texanol/1C (1:2 wt. ratio) (Control) | NE | NE | 34.8 | NE |
| Formulation VOC (g./liter) | | | 48 | |
| Scrub Resistance (cycles) | | | 323 | |
| DPG Dibenzoate (Control) | NE | NE | NE | 8.9 |
| Formulation VOC (g./liter) | | | | 4 |
| Scrub Resistance (cycles) | | | | 234 |
| Coalescent 2 | 8.0 | 14.3 | 29.0 | 8.9 |
| Formulation VOC (g./liter) | 92 | 66 | 20 | 5 |
| Scrub Resistance (cycles) | 3231 | 470 | 401 | 233 |
| Coalescent 3 | 8.0 | 16.7 | 34.8 | 8.9 |
| Formulation VOC (g./liter) | 94 | 71 | 29 | 6 |
| Scrub Resistance (cycles) | 5364 | 520 | 374 | 254 |

NE = formulation not evaluated
DPG = dipropylene glycol

The higher scrub resistance exhibited by compositions A, B and C containing coalescent 1 of the present invention relative to the same compositions containing Texanol and Texanol isobutyrate is unexpected based on the lower VOC level of the benzoate. mixture, coalescent 1, relative to Texanol and Texanol isobutyrate.

The monobenzoate concentrations of coalescents 2 and 3 are outside of the preferred range of 6 to 15 weight percent of the total benzoate combination. Coalescent 1 containing 12 weight percent of the monobenzoate is within this range. Coalescent 1 exhibited higher scrub resistance than coalescent 2 in two of the four formulations. The scrub resistance values of formulations containing coalescent 1 were higher than corresponding ones containing coalescent 3 in three of the four formulations.

The resistance to cycles of freezing and thawing of coating composition A containing each of the five coalescents was evaluated using ASTM test procedure D 2243. The sample containing Coalescent 1 withstood 3 cycles, demonstrating a superior resistance to the sample containing Texanol, which failed after only 1 cycle.

The samples of compositions C and D all failed after one freeze/thaw cycle, demonstrating equivalent performance for the present benzoate composition relative to Texanol.

The samples of composition C were evaluated for blocking resistance using ASTM test procedure D4946. The sample containing Coalescent 1 demonstrated equivalent performance relative to the control compositions.

### EXAMPLE 2

This example demonstrates the higher resistance to salt fog and methyl ethyl ketone exhibited by high gloss paint, referred to hereinafter as composition D. The paint was prepared by blending the following ingredients to homogeneity on a paint mill: 50 parts of water; 7.9 parts of Tamol® 2001, a dispersant from Rohm and Haas; 2.0 parts of Surfynol® CT-111, a surfactant from Air Product; 1.0 part of Drewplusl-493, a defoamer from Ashland; 2.0 parts of a 28% aqueous solution of ammonia; and 220.0 parts of Ti-Pure R-706, a white pigment. The resultant mixture was blended with 530 parts of Avanse MV-100, a polymer from Rohm and Haas; 132 parts of water; 7.0 parts of a 28% aqueous solution of ammonia; 18.5 parts of propylene glycol and one of the following benzoate ester combinations described in Example 1: coalescent 1—19.4 parts; coalescent 2—17.2 parts; coalescent 3—19.4 parts; 15.2 parts of DPnB/Texanol isobutyrate and coalescent 1c—19.4 parts.

Each of the paint compositions was applied to the appropriate substrate and allowed to dry for the specified time, following which the resultant coatings were evaluated for resistance to rusting following a 400-hour salt fog exposure using ASTM test B117 and chemical resistance by being rubbed with methyl ethyl ketone using the procedure described in ASTM test D4752.

The following results were observed:

| | Rust Following Salt Fog Exposure | Chemical Resistance |
|---|---|---|
| Coalescent | 10 = no rust; 1 = completely rusted | Double Rubs for Coating |
| 1 | 8 | 58 |
| 2 | 4 | 51 |
| 3 | 3 | 52 |
| 1c | 7 | 52 |

The results of this evaluation demonstrate that while benzoate combinations 1, 2 and 3 were all effective coalescents, only combination 1 with a monobenzoate content of 12 weight percent, which is within the preferred range of from 6 to 15.

That which is claimed is:

1. A low VOC aqueous composition comprising
A. at least one film-forming organic polymer;
B. as a coalescent/plasticizer for said polymer, an effective amount of a combination of benzoic acid esters comprising:
1) at least one diester of the formula PhC(O)(OR¹)qO(O)CPh;
2) from 6 to 99 weight percent, based on the total weight of said combination, of at least one monoester of the generic formula PhC(O)(OR²)ᵣOH, wherein R¹ and R² are individually at least one member selected from the group consisting of alkyl radicals containing 2 or 3 carbon atoms, Ph is phenyl or alkylphenyl, and q and r are individually integers from 1 to 6, inclusive;
3) from 0 to 10 weight percent, based on the total weight of said combination, of unreacted benzoic acid;
C. an amount sufficient to achieve the desired modification of films formed from said organic polymer of least one water-miscible compound selected from the group consisting of dihydric alcohols, glycols, oligomeric glycols, esters of said alcohols and glycols, and ethers, and
D. water.

2. A composition according to claim 1 wherein R¹ and R² are individually at least one of —OCH₂CH₂OCH₂CH₂—, —OCH₂(CH₃)CH₂OCH₂(CH₃)CH₂—, q and r are 2, said alkylphenyl radical is tolyl, the monobenzoate constitutes from 6 to 15 weight percent of said combination, said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, and epoxy-modified acrylic polymers.

3. A composition according to claim 2 wherein R¹ and R² are individually —OCH₂CH₂OCH₂CH₂— or —OCH₂(CH₃)CH₂OCH₂(CH₃)CH₂—, said film-forming polymer is selected from the group consisting of acrylic, vinyl/acrylic copolymers, styrenated acrylic and vinyl acetate/ethylene copolymers.

4. A composition according to claim 1 wherein said composition is a coating composition, an ink, an overprint varnish, a film, an adhesive, a caulk or a sealant.

5. A composition according to claim 1 wherein the property of a film formed from said composition that is to be modified by said organic compound is selected from the group consisting of resistance to scrubbing, solvents and salt fog, wetability, wet-edge, leveling, gloss development, adhesion, toolabilty, and resistance to gelling of said composition during freeze-thaw cycles.

6. A composition according to claim 1 wherein said combination of benzoic acid esters constitutes from 1 to 200 percent of the total weight of said film-forming polymer

7. A low VOC coalescent/plasticizer for low VOC aqueous coating composition, wherein said coalescent/plasticizer is a combination of benzoic acid esters comprising:
1) at least one diester of the formula PhC(O)(OR¹)_{q}O(O)CPh;
2) from 6 to 99 weight percent, based total weigh of said combination, of at least one monoester of the generic formula PhC(O)(OR²)ᵣOH, wherein R¹ and R² are individually at least one member selected from the group consisting of alkyl radicals containing 2 or 3 carbon atoms, Ph is phenyl or alkylphenyl, and q and r are individually integers from 1 to 6, inclusive; and
3) from 0 to 10 weight percent, based on the weight of said benzoate composition, of unreacted benzoic acid.

8. A coalescent/plasticizer composition according to claim 7 wherein R¹ and R² are individually at least one of —OCH₂CH₂OCH₂CH₂—, —OCH₂(CH₃)CH₂OCH₂(CH₃)CH₂—, q and r are 2, said alkylphenyl radical is tolyl and said monoester constitutes from 6 to 15 weight percent of said combination.

9. A product selected from the group consisting of coating compositions, films, sealants, inks, and overprint varnishes, wherein said product is a low VOC aqueous polymer composition comprising
A. at least one film-forming organic polymer;
B. as a coalescent/plasticizer for said polymer, an effective amount of a combination of benzoic acid esters comprising:
1) at least one diester of the formula PhC(O)(OR¹)_{q}O(O)CPh;
2) from 6 to 99 weight percent, based on the total weight of said combination, of at least one monoester of the generic formula PhC(O)(OR²)ᵣOH, wherein R¹ and R² are individually at least one member selected from the group consisting of alkyl radicals containing 2 or 3 carbon atoms, Ph is phenyl or alkylphenyl, and q and r are individually integers from 1 to 6, inclusive;
3) from 0 to 10 weight percent, based on the total weight of said combination, of unreacted benzoic acid;
C. an amount sufficient to achieve the desired modification of the properties of films formed from said organic polymer of least one compound selected from the group consisting of dihydric alcohols, glycols, oligomeric glycols, esters of said alcohols and glycols, and ethers, and
D. water.

10. A product according to claim 9 wherein R¹ and R² are individually at least one of —OCH₂CH₂OCH₂CH₂—, —OCH₂(CH₃)CH₂OCH₂(CH₃)CH₂—, q and r are 2, the monobenzoate constitutes from 6 to 15 weight percent of said combination, said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, and epoxy-modified acrylic polymers.

11. A product according to claim 10 wherein R¹ and R² are individually —OCH₂CH₂OCH₂CH₂— or —OCH₂(CH₃)CH₂OCH₂(CH₃)CH₂—, said film-forming polymer is selected from the group consisting of acrylic polymers, vinyl/acrylic copolymers, styrenated acrylics and vinyl acetate/ethylene copolymers.

12. A product according to claim 9 wherein the property of a film formed from said product that is to be modified by said organic compound is selected from the group consisting resistance to scrubbbing, solvents resistance, and salt fog, wetability, wet-edge, leveling, gloss development, adhesion, toolabilty, and resistance to gelling of said composition during freeze-thaw cycles.

13. A product according to claim 9 wherein said combination of benzoic acid esters constitutes from 1 to 200 percent of the total weight of said film-forming polymer.

14. A method for preparing a low VOC plasticized aqueous polymer composition, said method comprising blending to homogeneity ingredients comprising
A. at least one film-forming organic polymer;
B. as a coalescent/plasticizer for said polymer, an effective amount of a combination of benzoic acid esters comprising:
1) at least one diester of the formula PhC(O)(OR¹)_{q}O(O)CPh;
2) from 6 to 99 weight percent, based on the total weight of said combination, of at least one monoester of the generic formula PhC(O)(OR²)ᵣOH, wherein R² and R² are individually at least one member selected from the group consisting of alkyl radicals containing 2 or 3 carbon atoms, Ph is phenyl or alkyl phenyl, and q and r are individually integer from 1 to 6, inclusive;
3) from 0 to 10 weight percent, based on the weight of said combination, of unreacted benzoic acid;
C. an amount sufficient to achieve the desired modification of films formed from said organic polymer of least one compound selected from the group consisting of dihydric alcohols, glycols, oligomeric glycols, esters of said alcohols and glycols, and ethers, and
D. water.

15. A method according to claim 14 wherein R¹ and R² are individually at least one of —OCH₂CH₂OCH₂CH₂—, —OCH₂(CH₃)CH₂OCH₂(CH₃)CH₂—, q and r are 2, Ph is tolyl, the monobenzoate constitutes from 6 to 15 weight percent of said combination, said film-forming organic polymer is at least one member selected from the group consisting of homopolymers and copolymers of acrylic and methacrylic acids and esters thereof, copolymers of acrylic and methacrylic acids and esters thereof with styrene, vinyl monomers, and ethylene; vinyl acetate-ethylene copolymers, polyvinyl alcohol, polyurethanes, epoxide polymers, and epoxy-modified acrylic polymers.

16. A method according to claim 15 wherein R¹ and R² are individually —OCH₂CH₂OCH₂CH₂— or —OCH₂(CH₃)CH₂OCH₂(CH₃)CH₂—, said film-forming polymer is selected from the group consisting of acrylic, vinayl/acrylic copolymers, styrenated acrylic and vinyl acetate ethylene copolymers.

17. A method according to claim 14 wherein said polymer composition is a coating composition, an ink, an overprint varnish, a film, an adhesive, a caulk or a sealant.

18. A method according to claim 14 wherein the property of a film formed from said composition to be modified by said organic compound is selected from the group consisting of resistance to scrubbing, organic solvents and salt fog, wetability, wet-edge, leveling, gloss development, adhesion, toolabilty, and resistance to gelling of said composition during freeze-thaw cycles.

19. A method according to claim 14 wherein said combination of benzoic acid esters constitutes from 1 to 200 percent of the total weight of said film-forming polymer.

20. A solid substrate coated with a film of a coalesced low VOC aqueous polymer composition comprising:
A. at least one film-forming organic polymer;
B. as a coalescent/plasticizer for said polymer, an effective amount of a combination of benzoic acid esters comprising:
1) at least one diester of the formula PhC(O)(OR¹)_{q}O(O)CPh;
2) from 6 to 99 weight percent, based on the total weight of said combination, of at least one monoester of the generic formula PhC(O)(OR²)ᵣOH, wherein R¹ and R² are individually at least one member selected from the group consisting of alkyl radicals containing 2 or 3 carbon atoms, Ph is phenyl or alkyl phenyl, and q and r are individually integer from 1 to 6, inclusive;
3) from 0 to 10 weight percent, based on the weight of said combination, of unreacted benzoic acid;
C. an amount sufficient to achieve the desired modification of films formed from said organic polymer of least one compound selected from the group consisting of dihydric alcohols, glycols, oligomeric glycols, esters of said alcohols and glycols, and ethers and
D. water.
